(19) United States
(12) Patent Application Publication
(10) Pub. No.: US 2011/0017039 A1
(43) Pub. Date: Jan. 27, 2011

(54) Drum Shear Arrangement

(76) Inventors: Matthias Beuter, Bad Berleburg (DE); Bernhard Ehls, Hilchenbach (DE)

Correspondence Address: ABELMAN, FRAYNE & SCHWAB, 666 THIRD AVENUE, 10TH FLOOR, NEW YORK, NY, 10017, US

(21) Appl. No.: 12/735,606

(22) PCT Filed: Jan. 30, 2009
(86) PCT No.: PCT/EP2009/000625

§ 371 Date: Sep. 28, 2010

(30) Foreign Application Priority Data
Jan. 31, 2008 (DE) 10 2008 006 878.0

(51) Int. Cl. B23D 25/12; B23D 33/02

(52) U.S. Cl. 83/343; 83/436.7

(57) ABSTRACT

The invention relates to a drum shear arrangement (1) having two rotatably driven drums (3, 4) arranged on a stand (2) with their axes extending parallel to each other, and provided, respectively, with a knife (5, 6) on their profiles, wherein upon passing a metal sheet in a gap between the drums (3, 4), under at least partial rotation of the drums, the metal sheet is cuttable, and wherein inlet and/or outlet side of the stand is provided with at least one first roller group (10, 11) displaceable in a region of the stand (2) and in a region between the drums (3, 4).

### TECHNICAL FIELD

The invention relates to a drum shear arrangement, in particular, for cutting metal sheets and/or for passing slabs according to the preamble of claim 1.

### STATE OF THE ART

Drum shear arrangements are known in the state of the art, in which two drums are used for cutting strips or metal sheets and which are coaxially arranged and are rotatable in opposite direction, wherein on both drums, there are provided, respectively, knives or cutters that cut the passing sheet when the knives of both drums approach each other and are opposite each other. Such drum shear arrangements also cut sheet metal strips. It is also known that such drum shear arrangements have, in the region of the drums, flattenings which, when located opposite each other, are suitable for passing thick metal sheets through the drum shears, without cutting them. One of such drum shear arrangements is disclosed in EP O 162 020 A1.

It is known that with such drum shear arrangements, strips with a thickness from 20 mm to 40 mm are passed in and through a drum shear arrangement for cutting.

However, problems exists with thin strips having a thickness up to 4 mm when those have to be cut in the drum shear arrangement, and also when thick slabs of up to 150 mm have to be passed through the drum shear arrangement, without being cut.

With thin metal sheets or strips, it should be insured that the strips upon passing into the drum shear arrangement and after a separating cut, are reliably displaced onto the rollers of the next roller table and do not remain in the drum shear arrangement. With thick slabs, it is advantageous that a free passage can be achieved between the drums of the drum sheer arrangement between the upper knife-carrying drum and the lower knife-carrying drum.

### DESCRIPTION OF THE INVENTION, OBJECT, SOLUTION, ADVANTAGES

An object of the present invention is to provide a drum shear arrangement with which the above-mentioned requirements are achieved.

According to the invention, this object is achieved with a drum shear arrangement having two rotatably driven drums coaxially arranged on a stand and provided, respectively, with a knife on their profiles, wherein upon passing a metal sheet in a gap between the drums under at least partial rotation of the drums, the metal sheet is cuttable, and wherein inlet and/or outlet side of the stand is provided with at least one first roller group displaceable in a region of the stand.

By displacement in of at the least one roller group, it can be advantageously achieved that the metal sheet or strip is reliably fed in and is displaced out, wherein the at least one roller group at least partially is displaced out again in order not to interfere with rotation of the drums. According to the invention, it is expedient when the roller group is displaceable in and out at the inlet side and the outlet side.

It is particular advantageous when the at least one first roller group or both roller groups are horizontally displaceable with a drive on the inlet and outlet sides. With the drive, which can be formed as hydraulic, electrical, or electro-mechanical drive, one of the requirement associated with control of a horizontal position of the roller group, can be met.

It is further advantageous when the at least one first roller group or both first roller groups are vertically adjustable with a drive. Thereby, the adjustment of the height of the roller group can be purposely controlled, which is advantageous for feeding a metal strip in or out, as this facilitates achieving a necessary height for displacement onto a next roller group and prevents jamming or submerging.

It is further useful when in addition to a first roller group, at least one second roller group rotatable about an axis, is provided. Advantageously, the at least one second roller group is rotatable about the axis by a drive. Thereby, the second roller group can be pivoted into the plane of the roller table when necessary, or it can be lowered when it is not needed.

It is particularly useful when at least one drum or both drums has or have, on the side opposite the knife, a flattened profile, and/or has or have a cut-out.

It is particularly advantageous when the cut-out has a flattening having, on both sides, a section forming an angle with the flattening. These sections widen the flattening, extending at an angle to the flattening.

It is further useful when at least the lower drum has, on at least one side of the knife, on its circumference, a profile against which a sheet or a strip is supported. This profile is so formed that it forms or corresponds to an intended path of a sheet to a next roller or to a next roller group so that the sheet can take this path.

Further modifications are described in subclaims.

### BRIEF DESCRIPTION OF THE DRAWINGS

Below, the invention will be described in detail based on an embodiment of the invention with reference to the drawings.

The drawings show:

FIG. 1 a schematic view of a drum shear arrangement;

FIG. 2 a schematic view of a drum shear arrangement;

FIG. 3 a schematic view of a drum shear arrangement;

FIG. 4 a schematic view of a drum shear arrangement; and

FIG. 5 a schematic view of a drum shear arrangement.

### PREFERRED EMBODIMENT OF THE INVENTION

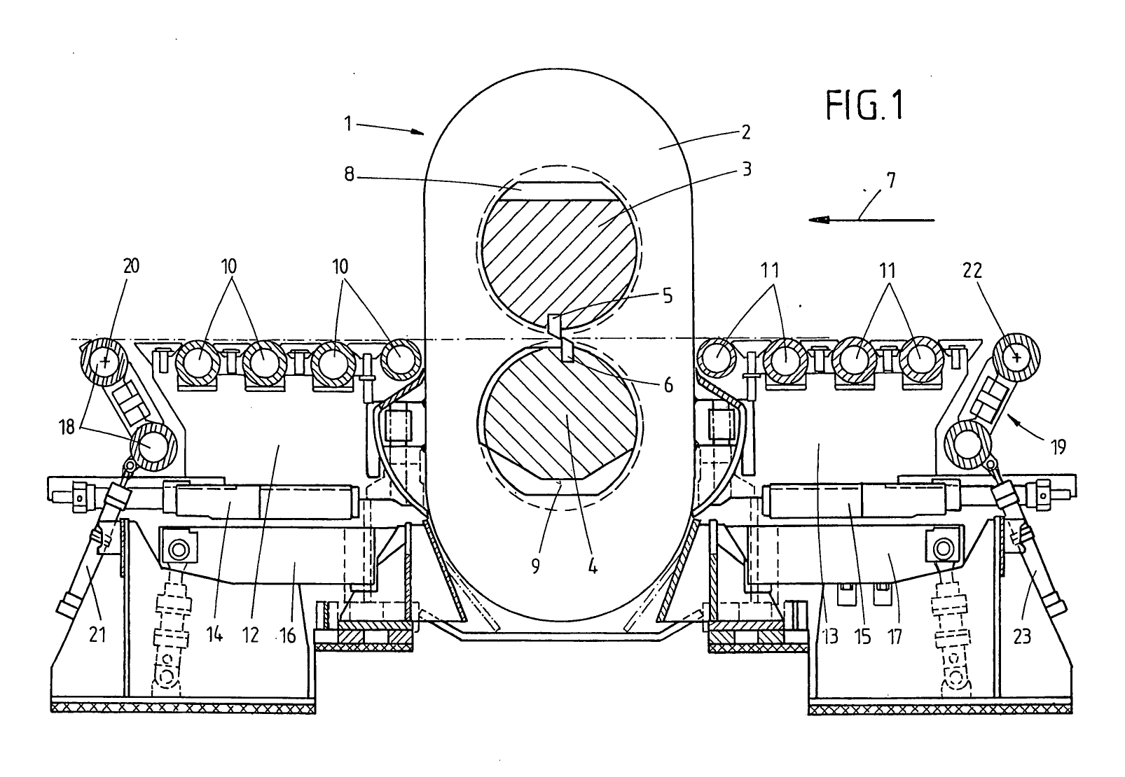

FIGS. 1-5 show an embodiment of the drum shear arrangement according to the present invention in different operational positions.

FIG. 1 shows schematically a drum shear arrangement 1 in which two drums 3, 4 are coaxially arranged in a stand 2 and are rotatably driven. A rotary drive of the drums 3, 4 is well known and will not be described here in detail. Each of the drums 3, 4 has a knife 5, 6, respectively, with which a passing metal sheet can be cut. The metal sheet is displaced through the drum shear arrangement 1 in direction indicated with arrow 7. The drums 3, 4 have a non-circular cross-section, rather they have flattenings 8 or cut-outs 9. The upper drum 3 has, on its side opposite the knife 5, a flattening 8 amounting to about a third of the drum radius in the height. The profile of the flattening extends transverse to the drum radius and is formed as a circular section. The lower drum 4 has, on its side opposite the knife 6, a cut-out 9 forming, in its middle, a flattening and an angled profile toward its sides.

In front and/or behind the drum stand 2, there are provided roller table-forming roller groups 10, 11 provided, respectively, with common frames 12, 13 and displaceable by the frames. The frames with the roller groups 10, 11 can be displaced, preferably, in a direction parallel to the strip displacement direction 7 or in an opposite direction. To this end, the frames 12, 13 are formed as horizontally displaceable slides, wherein to this end, there are available respective drives 14, 15, if necessary, with the drive being formed as a power take-off gear, for a horizontal displacement. In addition, the slides or frames 12, 13 are arranged or rotatably supported frames 16, 17, whereby the height position of the slides and, thereby, of roller groups 10, 11 are adjustable with respect to the height of the drums.

Further, as shown in FIG. 1, there are provided, in front and, preferably optionally, also behind the stand 2, at least one second roller group 18, 19 which is tiltable. In addition, dependent on an embodiment, only one second roller group 18, 19 can be arranged in front of or after the stand 2. The roller group 18 is pivotal about an axis 20 with a drive 21. It is advantageous when the drive 21 is electrical, or electro-mechanical, or hydraulic. The roller group 19 is pivotal, in FIG. 1, about an axis 22 with a drive 23. It is advantageous when the drive 23 is electrical, or electro-mechanical, or hydraulic.

In FIG. 1, the roller groups 10, 11 are arranged, respectively, outside of the stand 2 and adjacent thereto, and the roller groups 18, 19 are pivotal, respectively, downwardly.

FIG. 1 shows a configuration of the inventive drum shear arrangement 1 that is adjusted for cutting off the strips displaceable in the feeding direction 7. By the arrangement of the roller groups 10, 11 outside of the shears or the stand 2 and by lowering the roller groups, the cut-off scrap pieces after cutting are fed to a scrap sheet.

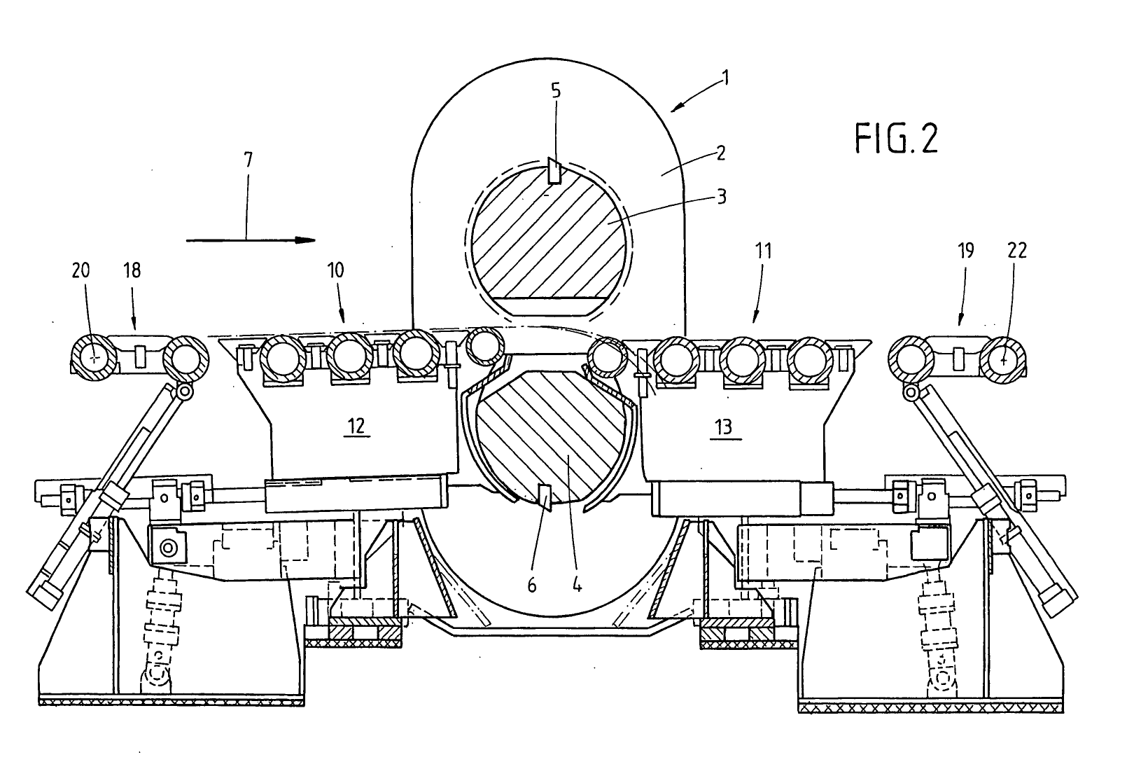

FIG. 2 shows the inventive drum shear arrangement 1 adjusted for feeding of a thin strip or metal sheet. The drums 3, 4 are so adjusted that the knives 5, 6 are provided somewhat at their uppermost or lowermost point. The roller groups 10 and 11 are displaced horizontally in the region of the stand 2 by a horizontal displacement of the slides 12, 13. Further, the roller group 10 is arranged at an elevated level and is somewhat inclined, whereas the roller group 11 is arranged horizontally.

As it can be seen, the roller groups 18 and 19 are pivoted about their pivot axis 21, 22 upwardly, quasi lengthening the roller tables formed by the roller group 10 or 11. Through the gap, which is formed between the drums 3, 4, a strip or a metal sheet can be fed into the drum shear arrangement 1. The spacing between the drums 3, 4 in this arrangement serves for passing slabs through the drum shear arrangement.

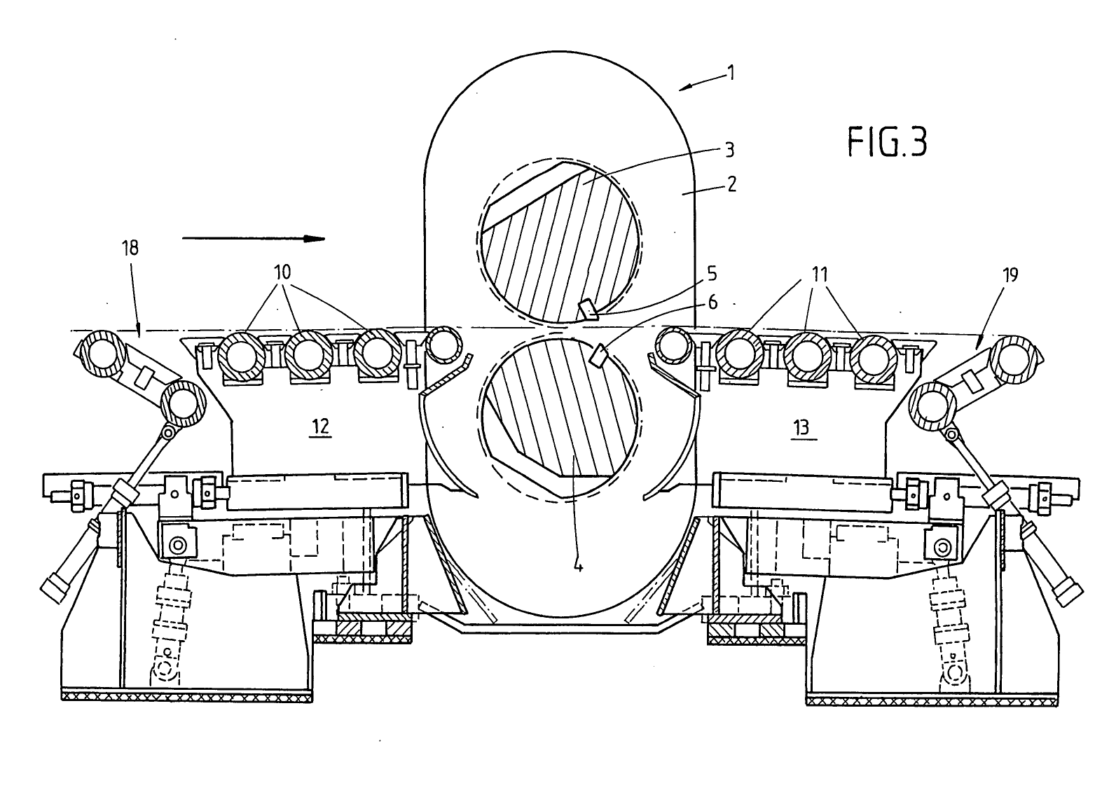

FIG. 3 shows the inventive drum shear arrangement in the condition of acceleration for cutting thin strips or metal sheets. The drums 3, 4 are so arranged that the knives 5, 6 are located in vicinity of their lower or upper point, and the knives 5, 6 are already closed to each other, so that a cut can be immediately carried out. The roller groups 10, 11 are horizontally displaced in the region of the stand 2 by a horizontal displacement of the slides 12, 13, though they are not displaced toward each other as far as in FIG. 2. Thus, the roller groups 10, 11, proceeding from the condition of FIG. 2, are displaced to the condition of FIG. 3, being displaced away from the stand 2. Simultaneously, they are lifted in their height in order to advantageously let the knives 5, 6 to pass over the roller groups. The roller groups 18 and 19 are again pivoted about their pivot axes downwardly, thereby being lowered.

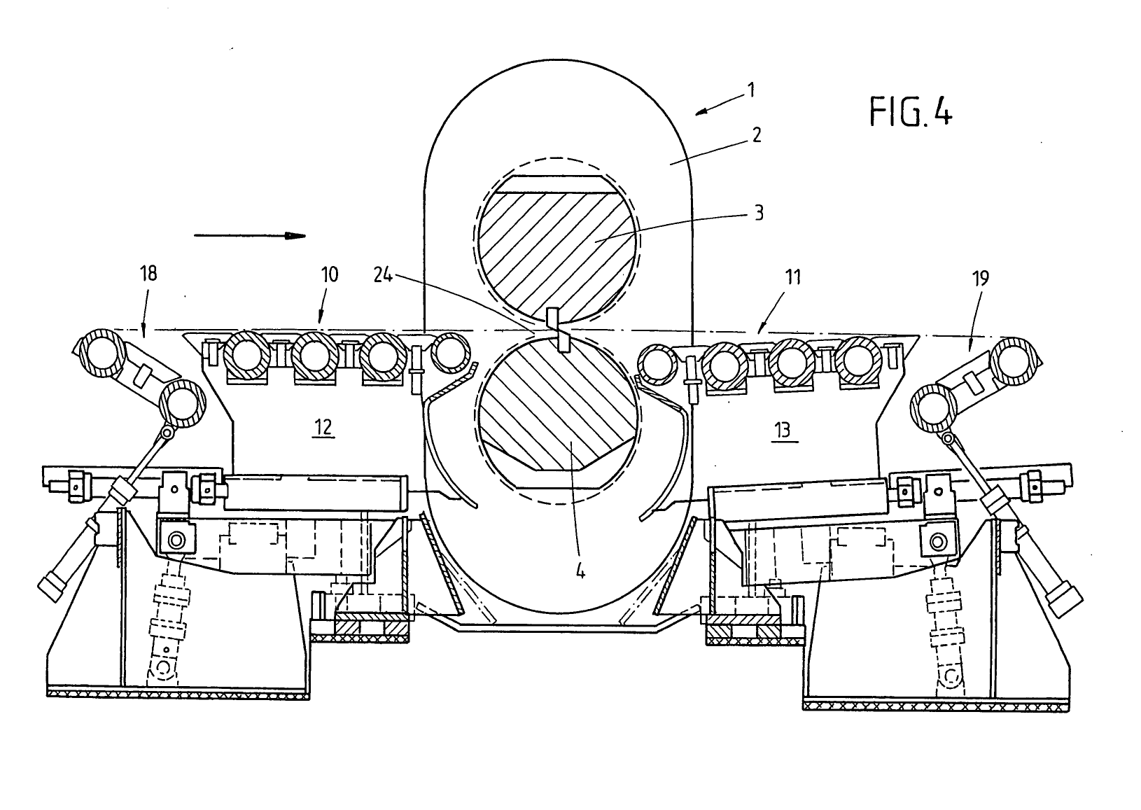

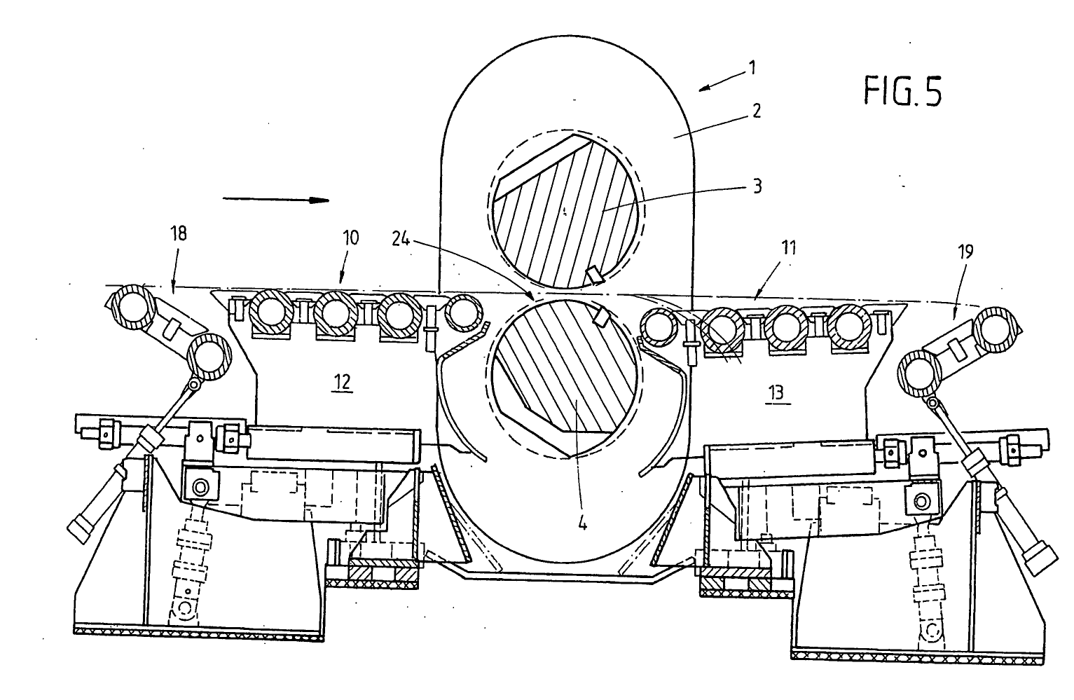

FIGS. 4 and 5 show the inventive drum shear arrangement 1, respectively, in a condition of cut and in a condition of displacement of the strip after the cut. For cutting and for displacement, the roller group 10 is arranged at the inlet at the roller table height, and the roller group 11 is at least somewhat lowered at the outlet. The profile 24 of the lower drum 4 serves for supporting the cut strip and against which the strip is supported when being transported out of the drum shear arrangement, so that the strip can reach the next roller group 11 after the shears.

### LIST OF REFERENCE NUMERALS

1 Drum shear arrangement
2 Stand
3 Drum
4 Drum
5 Knife, cutter
6 Knife, cutter
7 Arrow, displacement direction
8 Flattening
9 Cut-out
10 Roller group
11 Roller group
12 Frame
13 Frame
14 Drive
15 Drive
16 Frame
17 Frame
18 Roller group
19 Roller group
20 Axis
21 Drive
22 Axis
23 Drive
24 Profile

1. A drum shear arrangement (1), comprising two rotatably driven drums (3, 4) arranged on a stand (2) with their axes extending parallel to each other, and provided, respectively, with a knife (5, 6) on their profiles, wherein upon passing a metal sheet in a gap between the drums (3, 4), under at least partial rotation of the drums, the metal sheet is cuttable,
characterized in that
inlet and/or outlet side of the stand is provided with at least one first roller group (10, 11) displaceable in a region of the stand (2) and in a region between the drums (3, 4).

2. A drum shear arrangement (1) according to claim 1,
characterized in that
the at least one first roller group (10, 11) is horizontally displaceable with a drive (12, 13, 14, 15).

3. A drum shear arrangement (1) according to claim 1,
characterized in that
the at least one first roller group (10, 11) is vertically adjustable with a drive.

4. A drum shear arrangement (1) according to claim 1
characterized in that
there is provided at least one second roller group (18, 19) pivotable about an axis.

5. A drum shear arrangement (1) according to claim 4,
characterized in that
the at least one second roller group (18, 19) is pivotable about the axis (20, 22) with a drive (21, 23).

6. A drum shear arrangement (1) according to claim 1,
characterized in that
at least one drum (3, 4) or the drums (3, 4) has (have) on a side opposite the knife (5, 6) a flattened profile (8) and/or a cut-out (9).

7. A drum shear arrangement (1) according to claim 6,
characterized in that
the cut-out (9) has a flattening having, on both sides, a section forming an angle with the flattening.

8. A drum shear arrangement (1) according to claim 1,
characterized in that
at least the lower drum (4) has, on at least one side of the knife (6), on its circumference, a profile (24) against which a sheet or a strip is supported.
